(19) United States
(12) Patent Application Publication
(10) Pub. No.: US 2008/0068982 A1
(43) Pub. Date: Mar. 20, 2008

(54) System of routing path for redundancy ring and method thereof

(75) Inventors: Zuo-Jun Shih, Taipei (TW); Jen-Ta Jao, Taipei (TW)

Correspondence Address: BACON & THOMAS, PLLC, 625 SLATERS LANE, FOURTH FLOOR, ALEXANDRIA, VA, 22314, US

(73) Assignee: ANTASYS TECHNOLOGY CORPORATION, Taipei (TW)

(21) Appl. No.: 11/522,487

(22) Filed: Sep. 18, 2006

(51) Int. Cl. H04J 1/16; H04L 12/28

(52) U.S. Cl. 370/216; 370/254

(57) ABSTRACT

The invention presents a system of a static routing path for a redundancy ring in an Ethernet network and a method thereof. Meanwhile the method includes the steps of a) providing plural switches connected with each other to form communication links, wherein each of the plural switches has a forwarding device disposed therein for forming a static routing path; b) defining one of the plural switches as a root switch; c) issuing a topology change notification (TCN) packet and transmitting the TCN packet via the static routing path while another one of the plural switches has a failure in the communication links; d) receiving the TCN packet by the root switch; and e) issuing a topology change acknowledge (TCA) packet and transmitting the TCA packet to each of the plural switches via the static routing path, thereby completing network redundancy in a specific network recovery time.

### FIELD OF THE INVENTION

The present invention relates to a routing path of an Ethernet network, and more particularly, to a system of a routing path for redundancy ring in an Ethernet network.

### BACKGROUND OF THE INVENTION

Ethernet network redundancy is the ability of the network to survive a single cable failure in its switch-to-switch links. The network survives by providing alternate data path(s) when a cable fault occurs. Network redundancy is important to a user if the user has a system or process that is highly integrated and a failure in the communication links can result in disastrous consequences such as production loss, poor quality, equipment damage or danger to personnel.

The IEEE has published two protocols that deal specifically with network redundancy: Spanning Tree Protocol (STP) (IEEE 802.1D) and Rapid Spanning Tree Protocol (RSTP) (IEEE 802.1w). Spanning Tree Protocol (STP) allows networks to be wired in almost any topology. STP normally provides network recovery times of from 30 to 60 seconds. Rapid Spanning Tree Protocol (RSTP) is an updated form of STP and is backward compatible. This protocol was designed to provide a faster recovery time, generally, in 1 to 2 seconds.

Meanwhile, the network recovery time is the time it takes to restore the network after a cable failure. The faster the recovery time the better. A few minutes lost in an office environment is merely annoying and inconvenient, but even a few seconds interruption of an industrial communication network can result in thousands of dollars of lost production.

However, the prior art discloses methods of restoring the network after a cable failure via the software program merely. It should take a lot of time for running the program to select the forwarding way. Specially, STP normally provides network recovery times of from 30 to 60 seconds. In the prior system, one of switches is defined as a root one. When one connection of network is out of order, two switches connected with the broken one will issue topology change notification (TCN) packet to inform the root switch, and then the root switch will further issues a topology change acknowledge (TCA) to inform every switch in the network. Every switch in the network will renew the topology thereof by means of calculating via the program, and define new forwarding way for transmitting data. Meanwhile, STP/RSTP introduces control packets, called as bridge protocol data unit (BPDU) in IEEE standard. According to the prior art, when BPDU, control packet, is transmitted through a switch, the switch should select a forward way of the BPDU by means of calculating via the program. However, several multi-type switches could have different CPU performances for calculating. There is a max forwarding delay time defined for solving the above problem, wherein the max forwarding delay time limits the BPDU transmitting time from one switch to another switch. For example, the max forwarding delay time of STP/RSTP is set in 15 seconds, and then BPDU should take 30 seconds to make a round trip. On the other words, all switches could make sure of receiving TCA after 30 seconds, and then the topology of new forwarding way for transmitting data is finished. As we known, a failure in the communication links can result in disastrous consequences such as production loss, poor quality, equipment damage or danger to personnel. However, STP normally provides network recovery times of from 30 to 60 seconds. RSTP normally provides a faster recovery time in 1 to 2 seconds, but in some situation, the recovery time of RSTP could be 30 seconds. Obviously, it is unacceptable for the application of any industrial enterprise.

Therefore, in practice, the prior art should waste more time for solving the problem of network redundancy. On the other hand, it is difficult to implement. Hence, it needs to provide a system of a routing path for redundancy ring in an Ethernet network, is capable of achieving the purpose of decreasing the network recovery time, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a system of a static routing path for redundancy ring in an Ethernet network, is capable of achieving the purpose of decreasing the network recovery time, and can rectify those drawbacks of the prior art and solve the above problems.

In accordance with an aspect of the present invention, the system of a routing path for redundancy ring, includes plural switches connected with each other to form communication links, wherein one of the plural switches is defined as a root switch for issuing a topology change acknowledge (TCA) packet while another one of the plural switches has a failure in the communication links and a topology change notification (TCN) packet is issued; and plural forwarding devices disposed in relation to the plural switches to form a routing path, wherein the TCN packet and the TCA packet are transmitted in the routing path defined by the plural forwarding devices.

Preferably, the TCA packet and the TCN packet comply with bridge protocol data unit (BPDU).

Preferably, the TCA packet and the TCN packet are control packets.

Preferably, the plural forwarding devices are computer hardware.

Preferably the TCN packet and the TCA packet include different destination MAC addresses.

Preferably, each of the plural switches includes plural ports defined to forward the TCN packet and the TCA packet in response to the destination MAC addresses.

Certainly, the TCN packet and the TCA packet can be forwarded by relative one of the forwarding devices in 0.1 msec.

Preferably, the root switch issues the TCA packet after receiving the TCN packet.

Certainly, the TCN packet can be issued from two adjacent switches next to the another one of the plural switches with the failure in the communication links.

It is an object of the present invention to provide a method of a routing path for redundancy ring in an Ethernet network, is capable of achieving the purpose of decreasing the network recovery time, and can rectify those drawbacks of the prior art and solve the above problems.

In accordance with an aspect of the present invention, the method of a routing path for redundancy ring, includes the steps of a) providing plural switches connected with each other to form communication links, wherein each of the plural switches has two routing paths to forward data packet to neighboring switches; b) defining one of the plural switches as a root switch; c) issuing a topology change notification (TCN) packet and transmitting the TCN packet via the survival routing path while a communication link of ring has been broken between two switches; d) receiving the TCN packet by the root switch; and e) issuing a topology change acknowledge (TCA) packet and transmitting the TCA packet to each of the plural switches; and f) receiving the TCA packet by non-root switches and changing routing path of data packet, thereby completing network redundancy in a specific network recovery time.

Certainly, the TCA packet and the TCN packet comply with bridge protocol data unit (BPDU).

Certainly, the TCA packet and the TCN packet can be control packets.

Certainly, the forwarding device can be computer hardware.

Preferably, the TCN packet and the TCA packet include two different destination MAC addresses.

Preferably, each of the plural switches includes plural ports defined to forward the TCN packet and the TCA packet in response to the destination MAC addresses.

Preferably the step c) further includes step c1) of forwarding the TCN packet by the forwarding device while the TCN packet is transmitted through the plural switches.

Preferably, the step e) further comprises step e1) of forwarding the TCA packet by the forwarding device while the TCA packet is transmitted through the plural switches.

Certainly, the TCN packet can be issued from two switches next to the another one of the plural switches with the failure in the communication links.

Certainly, the TCA packet can be issued from the root switch.

Certainly, the specific network recovery time can be shorter than 0.1 msec.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates a preferred embodiment of a system of a routing path for redundancy ring according to the present invention; and

FIG. 2 illustrates a preferred embodiment of a method of a routing path for redundancy ring according to the present invention.

### DETAILED DESCRIPTION OF THE PREFERRED EMBODIMENT

The present invention discloses a system of a routing path for redundancy ring in an Ethernet network and a method thereof, and the objects and advantages of the present invention will become more readily apparent to those ordinarily skilled in the art after reviewing the following detailed description. The present invention needs not be limited to the following embodiment.

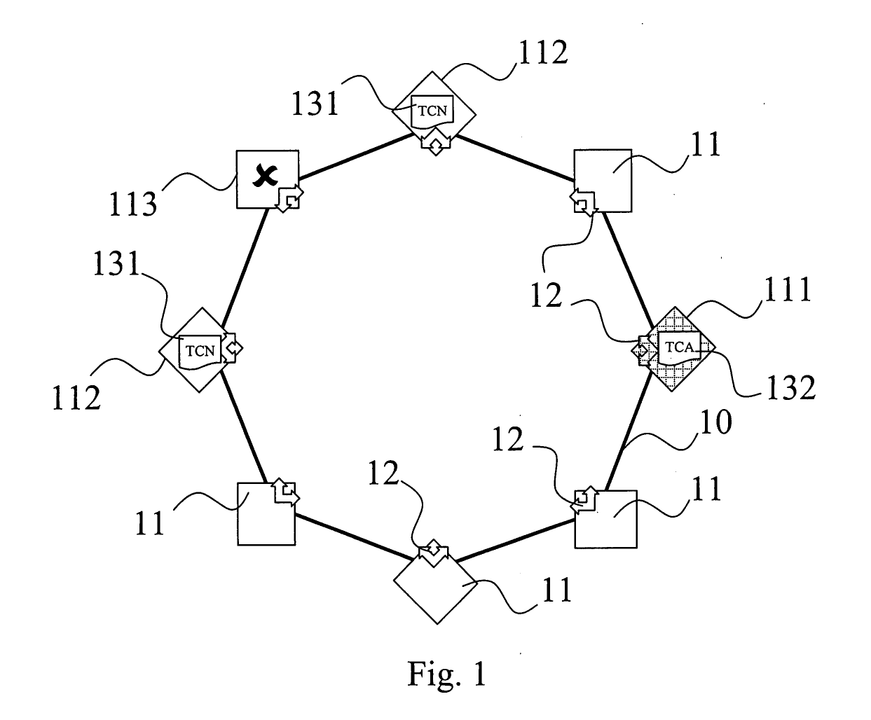

Please refer to FIG. 1. It illustrates a preferred embodiment of a system of a routing path for redundancy ring according to the present invention. As shown in FIG. 1, the system 10 of a routing path for redundancy ring, includes plural switches 11 connected with each other, wherein one of the plural switches 11 is defined as a root switch 111 for issuing a topology change acknowledge (TCA) packet 132 while one of the plural switches 113 has a failure in the communication links (the connection line is broken) and a topology change notification (TCN) packet 131 is issued; and plural forwarding devices 12 disposed in relation to the plural switches to form a routing path, wherein the TCN packet 131 and the TCA packet 132 are transmitted in the routing path defined by the plural forwarding devices.

Certainly, the TCA packet 132 and the TCN packet 131 are control packets transmitted among the plural switches 11. More particularly, the plural forwarding devices 12 disposed in every switch 12 are computer hardware, which could forward BPDU in the shorter time. In the present invention, the TCN packet 131 and the TCA packet 132 include different destination MAC addresses. Certainly, each of the plural switches 11 respectively includes plural ports (not shown) defined to forward the TCN packet 131 and the TCA packet 132 in response to the destination MAC addresses. According to the structure of the present invention, the TCN packet 131 and the TCA packet 132 can be forwarded by relative one of the forwarding devices 12 in 0.1 msec.

In practice, the present invention provides a system of a routing path for redundancy ring in an Ethernet network to deal with the problem of network redundancy. The system, which introduces computer hardware as the forwarding device according to the present invention, could renew the topology of the network in 0.1 msec. When one of the plural switches 113 has a failure in the communication links, the TCN packet 131 can be issued from two adjacent switches 112 next to the another one of the plural switches 113 with the failure in the communication links, as shown in FIG. 1. After a topology change notification (TCN) packet 131 with a special destination MAC address to root switch is issued, the TCN packet 131 will transmit through several switches and to the root switch 111 finally, wherein TCN packet 131 is transmitted through several switches and forwarded quickly in the routing path by the forwarding devices thereof. After receiving the TCN packet 131, the root switch 111 will issue a topology change acknowledge (TCA) packet 132 with a special destination MAC address and broadcast to every switch of the system. Meanwhile, the TCA packet 132 is transmitted according to the special destination MAC address. Similarly, TCA packet 132 is transmitted through several switches and forwarded quickly in the routing path by the forwarding devices thereof. When every switch receives the TCA packet 132 for itself, the system has renewed the topology thereof. The system, with the forwarding device of the present invention, could renew the topology of the network in 0.1 msec.

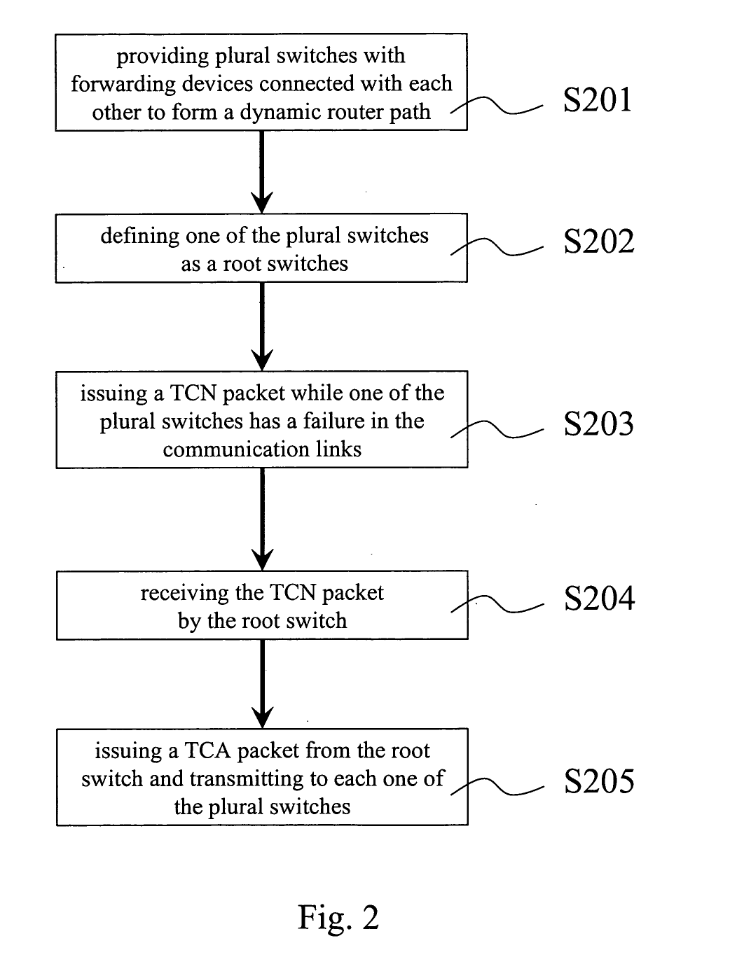

Additionally, the present invention further discloses a method of a routing path for redundancy ring. Please refer to FIG. 2. It illustrates a preferred embodiment of a method of a routing path for redundancy ring according to the present invention. As shown in FIG. 2, the method of a routing path for redundancy ring, includes the steps of a) providing plural switches 11 connected with each other (Please refer to FIG. 1, too), wherein each of the plural switches 11 has a forwarding device 12 disposed therein for forming a routing path, as shown in the procedure S201; b) defining one of the plural switches 11 as a root switch 111, as shown in the procedure S202; c) issuing a topology change notification (TCN) packet 131 and transmitting the TCN packet via the routing path while one of the plural switches 113 has a failure in the communication links, as shown in the procedure S203, wherein TCN packet 131 is transmitted through several switches and forwarded quickly in the routing path by the forwarding devices thereof; d) receiving the TCN packet 131 by the root switch 111, as shown in the procedure S204; and e) issuing a topology change acknowledge (TCA) packet from the root switch 111 and transmitting the TCA packet to each of the plural switches 11 via the routing path, as shown in the procedure S205, thereby completing network redundancy and renewing the topology in a specific network recovery time.

Meanwhile, the TCA packet 132 and the TCN packet 131 are bridge protocol data unit (BPDU) in IEEE standard. Certainly, the TCA packet 132 and the TCN packet 131 are control packets transmitted among the plural switches 11. More particularly, the plural forwarding devices 12 disposed in every switch 12 are computer hardware, which could forward BPDU in the shorter time. For transmitting the control packets to the specific destination, the TCN packet 131 and the TCA packet 132 include different destination MAC addresses.

In practice, the step c) further includes step c1) of forwarding the TCN packet by the forwarding device while the TCN packet is transmitted through the plural switches. Similarly, the step e) further includes step e1) of forwarding the TCA packet by the forwarding device while the TCA packet is transmitted through the plural switches. In step c), when one of the plural switches 113 has a failure in the communication links, as shown in FIG. 1, the TCN packet 131 can be issued from two adjacent switches 112 next to the another one of the plural switches 113 with the failure in the communication links and transmitted to the destination, root switch 111, in response to the destination MAC address of the TCN packet 131. When the TCN packet 131 is still transmitted through several switches 11 instead of the root switch 111, the TCN packet 131 is forwarded quickly in the outer path by the forwarding device thereof according to the present invention. On the other hand, the TCA packet 132 is issued by the root switch 111 and transmitted to the destination, every switch 11, in response to the specific destination MAC address of the TCA packet 132. Certainly, the specific network recovery time can be shorter than 0.1 msec. When the TCA packet 132 is still transmitted through several switches 11 instead of the destination one, the TCA packet 132 is forwarded quickly in the outer path by the forwarding device thereof according to the present invention. More specially, the method of the present invention, which introduces computer hardware as the forwarding device in the step c) and the step e), could renew the topology quickly, wherein the network system could deal with the problem of network redundancy in 0.1 msec.

In conclusion, the present invention provides a system of a static routing path for redundancy ring in an Ethernet network, is capable of achieving the purpose of decreasing the network recovery time, and can rectify those drawbacks of the prior art and solve the above problems. The present invention further discloses a system of a routing path with hardware forwarding device to forward control packets for decreasing the network recovery time, thereby the network recovery time being shorter than 0.1 msec. Meanwhile the prior art fail to disclose that. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A system of a routing path for redundancy ring, comprising:
plural switches connected with each other to form communication links, wherein one of said plural switches is defined as a root switch for issuing a topology change acknowledge (TCA) packet while another one of said plural switches has a failure in said communication links and a topology change notification (TCN) packet is issued; and
plural forwarding devices disposed in relation to said plural switches to form a static routing path, wherein said TCN packet and said TCA packet are transmitted in said static routing path defined by said plural forwarding devices.

2. The system according to claim 1, wherein said TCA packet and said TCN packet comply with bridge protocol data unit (BPDU).

3. The system according to claim 1, wherein said TCA packet and said TCN packet are control packets.

4. The system according to claim 1, wherein said plural forwarding devices are computer hardware.

5. The system according to claim 1, wherein said TCA packet and said TCN packet comprise different destination MAC addresses.

6. The system according to claim 5, wherein each of said plural switches comprises plural ports defined to forward said TCN packet and said TCA packet in response to said destination MAC addresses.

7. The system according to claim 1, wherein said TCN packet and said TCA packet are forwarded by relative one of said forwarding devices in 0.1 msec.

8. The system according to claim 1, wherein said root switch issues said TCA packet after receiving said TCN packet.

9. The system according to claim 1, wherein said TCN packet is issued from two adjacent switches next to said another one of said plural switches with said failure in said communication links.

10. A method of a routing path for redundancy ring, comprising the steps of:
a) providing plural switches connected with each other to form communication links, wherein each of said plural switches has a forwarding device disposed therein for forming a static routing path;
b) defining one of said plural switches as a root switch;
c) issuing a topology change notification (TCN) packet and transmitting said TCN packet via said static routing path while another one of said plural switches has a failure in said communication links;
d) receiving said TCN packet by said root switch; and
e) issuing a topology change acknowledge (TCA) packet and transmitting said TCA packet to each of said plural switches via said static routing path, thereby completing network redundancy in a specific network recovery time.

11. The method according to claim 10, wherein said TCA packet and said TCN packet comply with bridge protocol data unit (BPDU).

12. The method according to claim 10, wherein said TCA packet and said TCN packet are control packets.

13. The method according to claim 10, wherein said forwarding device is computer hardware.

14. The method according to claim 10, wherein said TCN packet and said TCA packet comprise different destination MAC addresses.

15. The method according to claim 14, wherein each of said plural switches comprises plural ports defined to forward said TCN packet and said TCA packet in response to said destination MAC addresses.

16. The method according to claim 10, wherein said step c) further comprises step cl) of forwarding said TCN packet by said forwarding device while said TCN packet is transmitted through said plural switches.

17. The method according to claim 10, wherein said step e) further comprises step e1) of forwarding said TCA packet by said forwarding device while said TCA packet is transmitted through said plural switches.

18. The method according to claim 10, wherein said TCN packet is issued from two adjacent switches next to said another one of said plural switches with said failure in the communication links.

19. The method according to claim 10, wherein said TCA packet is issued from said root switch.

20. The method according to claim 10, wherein said specific network recovery time is shorter than 0.1 msec.
